(19) United States
(12) Patent Application Publication
(10) Pub. No.: US 2005/0060409 A1
(43) Pub. Date: Mar. 17, 2005

(54) Managing resources of chassis that include configurable network diagnostic modules

(76) Inventors: Jean-Francois Dube, Santa Clara, CA (US); George Anthony Bullis, Glendoa, CA (US)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/925,492

(22) Filed: Aug. 25, 2004

Related U.S. Application Data
(60) Provisional application No. 60/498,196, filed on Aug. 26, 2003.

(51) Int. Cl. G06F 15/173

(52) U.S. Cl. 709/226

(57) ABSTRACT

The present invention provides for managing resources of chassis that include configurable network diagnostic modules. A computer system receives a request to allocate a chassis resource to a requesting entity. The computer system sends an allocation request message to a chassis that includes the chassis resource. The chassis receives an allocation request message from the requesting computer system. The chassis determines if the requested chassis resource is currently being utilized. The chassis refers to allocation rules to determine if the requested chassis resource can be allocated to satisfy the resource allocation request. The chassis allocates one or more resources according to the allocation rules and returns an allocation response to the requesting computer system. The computer system receives the allocation response and presents the allocation response at the requesting computer system.

### CROSS REFERENCE TO RELATED APPLICATIONS

The present application claims priority to U.S. Provisional Patent Application Ser. No. 60/498,196 entitled “Managing Resources Of Chasses That Include Configurable Network Diagnostic Modules”, filed Aug. 26, 2003, which is hereby incorporated by reference.

### BACKGROUND OF THE INVENTION

1. The Field of the Invention

The present invention relates generally to data transmission systems and components. More particularly, embodiments of the present invention relate to managing resources of chassis that include configurable network diagnostic modules.

2. Background and Relevant Art

Computer and data communications networks continue to proliferate due to declining costs, increasing performance of computer and networking equipment, and increasing demand for communication bandwidth. Communications networks—including wide area networks (“WANs”), local area networks (“LANs”), and storage area networks (“SANs”)—allow increased productivity and utilization of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”) and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind many advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, a few years ago, the highest rate that data could travel across a network was at about one Gigabit per second. This rate has increased to the point where data can travel across Ethernet and SONET networks at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

Consequently, as high speed data communications systems, processes and devices mature, many designs have increasingly focused on reliability and performance issues. Accordingly, a number of diagnostic devices and tests can be utilized to aid a network administrator in both identifying existing network conditions that are causing a network to deviate from expected performance and proactively identifying network conditions that may cause a network to deviate from expected performance in the future.

One device that is used to identifying network conditions is a protocol analyzer, also called a network analyzer. Generally, a protocol analyzer runs in the background of a network, capturing, examining and logging packet traffic. Protocol analyzers can, for example, be configured to watch for unusual IP addresses, time stamps and data packets, and most have a user interface for enabling the network administrator to have access to information representing the analysis performed by the protocol analyzers. Protocol analyzers are thus a fundamental and highly useful tool for testing and debugging various types of communications networks, including computing and computer storage networks.

A protocol analyzer operates by capturing selected portions of data from a data stream that is transmitted via the communications network. The captured information may then be analyzed in greater detail by the protocol analyzer to extract desired information. For example, data transmission faults or errors, or performance errors, known generally as problem conditions, may be diagnosed by examining the captured data that is related to the problem.

Another device that is used to identify network conditions is a generator. Generally, generators generate network traffic to simulate various network conditions. For example, a generator can generate network traffic that simulates a data stream between two nodes on a network. The behavior of the two nodes, as well as other nodes of the network, can be evaluated to determine how the network responds to the simulated data stream. Thus, a network administrator may be able to identify performance deviations and take appropriate measures to prevent the performance deviations from occurring in the future.

Another device that is used to identify network conditions is a bit error rate tester. Generally, bit error rate testers operate by transmitting a predetermined bit sequence onto the data transmission path, and then analyze the predetermined bit sequence when it returns to the bit error rate tester. Typically, such analyses involve comparing the received bit sequence to a copy of the bit sequence that was initially transmitted onto the data transmission path. This comparison permits errors within the sequence to be identified and counted. After the errors in the bit sequence are counted, that information is used to calculate an overall bit error rate. If the bit error rate is too high, the data transmission path and its physical layer should be inspected. Some protocol's specifications expect the bit error rate to be less than a specific value.

Another device that is used to identify network conditions is a jammer. Generally, jammers provide the ability to selectively alter channel data, including the introduction of errors into channel data paths. Thus, jammers permit monitoring of the response of the communications system to the altered data, and help determine whether the communications system is capable of responding without experiencing adverse effects in performance such as loss of data or network traffic interruption. For example, a network system designer can perform any one of a number of different diagnostic tests to make determinations such as whether a system responded appropriately to incomplete, misplaced or missing tasks or sequences, how misdirected or confuising frames are treated, and how misplaced ordered sets are treated.

Protocol analyzers, generators, bit error rate testers, and jammers (and possibly other devices that test for network conditions) can be implemented on printed circuit boards (often referred to as “cards” or “blades”) that are inserted into a computer system test chassis. Depending on the desired functionality, an administrator can insert a particular type of card into a computer system test chassis. For example, when an administrator desires to test a bit error rate for a network, the administrator can insert a bit error rate tester card into a computer system test chassis. Subsequently, when the administrator desires to analyze network traffic, the administrator can remove the bit error rate test card from the computer system test chassis and insert a network analyzer card into the computer system test chassis.

Some computer system test chassis even include multiple card receptacles such that the computer system test chassis can receive a number of cards. Thus, an administrator may have some flexibility to simultaneously test a network for a variety of network conditions. For example, an administrator may include a generator card and a jammer card in a multi-receptacle computer system test chassis to simultaneously utilize both generator and jammer functionality. Unfortunately, as a network expands and/or is reconfigured, the requirements for testing the network can change. Expansion and/or reconfiguration of a network can result in an administrator having to, at least from time-to-time, reconfiguring the network testing functionality for a network.

Further, diagnostic modules can also be simultaneously used by multiple client programs across a network, for example, by different computer systems and/or by different users. Thus, the actions of one user or client program can potentially interfere with the work of another user or client program. Therefore systems, methods, and computer program products for managing resources of chassis that include configurable network diagnostic modules would be advantageous.

### BRIEF SUMMARY OF THE INVENTION

The foregoing problems with the prior state of the art are overcome by the principles of the present invention, which are directed towards methods, systems, and computer program products for managing resources of chassis that include configurable network diagnostic modules. A computer system is network connectable to one or more chassis that each contains one or more network diagnostic modules. The computer system receives a request to allocate a chassis resource to a requesting entity. The computer system sends an allocation request message to a chassis that includes the chassis resource. The chassis receives an allocation request message from the requesting computer system.

The chassis determines if the requested chassis resource is currently being utilized. The chassis refers to allocation rules to determine if the requested chassis resource can be allocated to satisfy the resource allocation request. The chassis allocates one or more resources according to the allocation rules and returns an allocation response to the requesting computer system. The computer system receives the allocation response and presents the allocation response at the requesting computer system.

Additional features and advantages of the invention will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of network architecture and associated modules and data structures for managing resources of chassis that include configurable network diagnostic modules in accordance with the principles of the present invention.

FIG. 2 illustrates a flowchart of an example method for managing resources of chassis that include configurable network diagnostic modules in accordance with the principles of the present invention.

FIG. 3 illustrates an example chassis computer system architecture including a plurality of network diagnostic modules in accordance with the principles of the present invention.

FIG. 4 illustrates a suitable operating environment for the principles of the present invention.

FIG. 5 illustrates an example of a network diagnostic module and diagnostic ports that can interoperate to implement a network diagnostic function in accordance with the principles of the present invention.

FIG. 6 illustrates an example user-interface screen for presenting discovered chassis and resources.

FIG. 7 illustrates an example user-interface screen for presenting organized ports.

FIG. 8 depicts a first example user-interface screen for presenting more detailed information for a port, slot, chassis, and sync group.

### DETAILED DESCRIPTION OF THE PREFERRED EMBODIMENTS

The principles of the present invention provide for managing resources of chassis that include configurable network diagnostic modules. A computer system is network connectable to one or more chassis that each contains one or more network diagnostic modules. The computer system receives a request to allocate a chassis resource to a requesting entity. The computer system sends an allocation request message to a chassis that includes the chassis resource. The chassis receives an allocation request message from the requesting computer system.

The chassis determines if the requested chassis resource is currently being utilized. The chassis refers to allocation rules to determine if the requested chassis resource can be allocated to satisfy the resource allocation request. The chassis allocates one or more resources according to the allocation rules and returns an allocation response to the requesting computer system. The computer system receives the allocation response and presents the allocation response at the requesting computer system.

Each network diagnostic module includes one or more programmable logic modules (e.g., one or more Field Programmable Gate Arrays (“FPGAs”) that include circuitry for implementing any of a plurality of different network diagnostic functions (e.g., network analyzer, jammer, generator, bite rate error test, etc). Each programmable logic module controls one or more test ports that provide interfaces for different physical configurations (e.g., Gigabit Ethernet, Fiber Distributed Data Interface, Fibre Channel, Serial Attached SCSI (“SAS”), Serial ATA (“SATA”), etc.) and that can interoperate with the programmable logic module to implement a selected network diagnostic function. In some embodiments, a network diagnostic module is included in a printed circuit board (hereinafter referred to as a “card” or “blade”) that is inserted into an appropriate receptacle at a chassis (e.g., using a Peripheral Component Interconnect (“PCI”) interface). Accordingly, the network diagnostic module may receive data through electrical contacts of the receptacle.

Generally, a network diagnostic module receives a bit file with instructions for implementing a selected diagnostic function at one or more test ports that interface with a network. A bit file contains programming data to program a programmable logic module (e.g., an FPGA) to have a specific function. A bit file can be received from a mass storage device or even from a memory location at the computer system. Programming data can include computer-executable instructions, computer-interpretable instructions, or circuit design data (for a programmable logic module) that is processed by the network diagnostic module to implement the selected network diagnostic function. The network diagnostic module identifies a programmable logic module (e.g., an FPGA) that controls the one or more test ports. The network diagnostic module loads the included programming data at the identified programmable logic module to cause the programmable logic module and the one or more test ports to interoperate to implement the selected diagnostic function. Accordingly, programming data contained in a bit file can be loaded at an FPGA to cause the FPGA to implement any of a network analyzer, jammer, bit error rate tester, generator, etc. When a new implementation is desired (e.g., changing from a jammer to a bit error rate tester) instructions from a new bit file can be loaded.

It may be that a network diagnostic function is part of a “port personality” represented in a bit file. For example, a port personality can include a network diagnostic function, a clock rate (e.g., 1.0625, 2.125, or 2.5 Gigabits per second), and a protocol (e.g., Fibre Channel, Gigabit Ethernet, Infiniband, etc). Thus, a programmable logic module can process computer-executable instructions, computer-interpretable instructions, or circuit design data to cause a programmable logic module and a corresponding test port or test ports to interoperate to implement a port personality in accordance with the processed computer-executable instructions, computer-interpretable instructions, or circuit design data. For example, a programmable logic module can process instructions from a bit file to cause the programmable logic module and corresponding test ports to interoperate to implement a Fibre Channel jammer (i.e., a real-time error injector) at 2.125 Gbps. Accordingly, the personality of the corresponding test ports can include implementation of a particular network diagnostic function.

In some embodiments, a number of network diagnostic modules are included in a common chassis computer system. Thus, chassis having increased numbers of flexibly configurable test ports can be utilized to test a network. A chassis can include a mass storage interface for transferring network diagnostic data to and/or from a mass storage device, a trigger port for detecting the occurrence of events, an interconnect port for connecting to other chassis, and a remote access port for receiving commands from remote computer systems. Connected chassis can exchange control signals over links between corresponding interconnect ports. Accordingly, network diagnostic modules at a number of different chassis can be controlled from any of the other chassis. Connecting a number of chassis together can further increase the number test ports utilized to test a network.

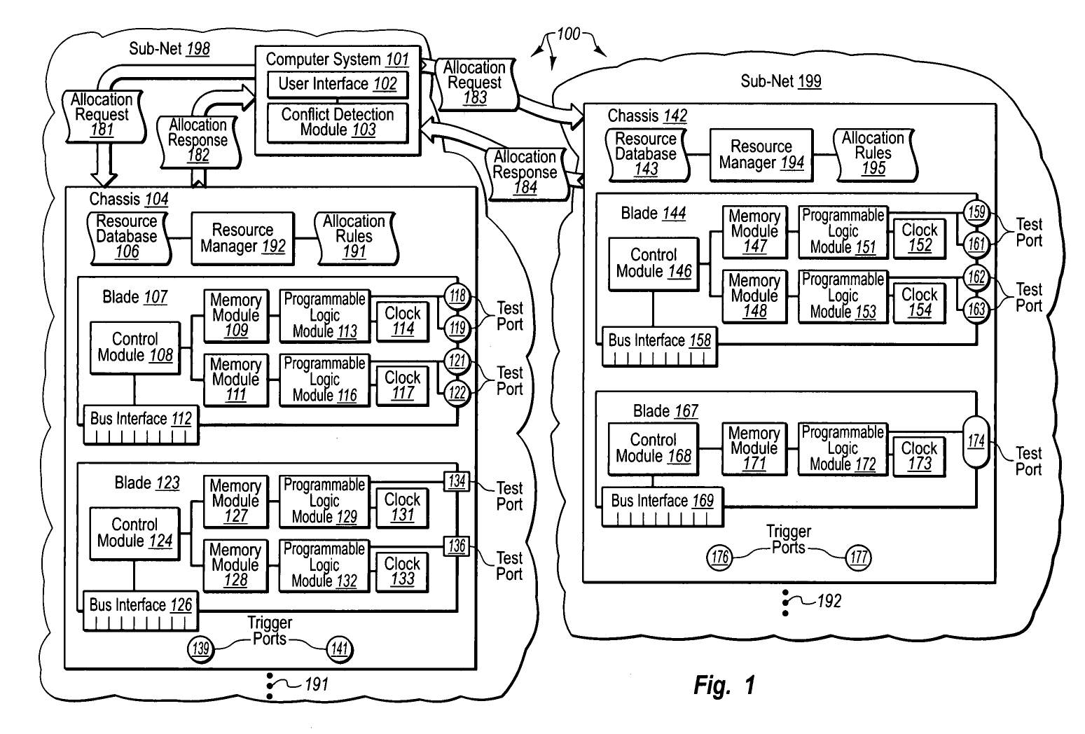

FIG. 1 illustrates an example of network architecture 100 and associated modules and data structures for managing resources of chassis that include configurable network diagnostic modules in accordance with the principles of the present invention. FIG. 1 depicts computer system 101 that is network connectable to chassis 104 and 142. Computer system 101 includes user interface 102 that can discover and present chassis, blade, and port information to a user at computer system 101.

User interface 102 can be configured to query for resource data maintained at chassis (e.g., by sending an appropriate request to a corresponding network address). User interface 102 can present resource data returned in response to queries. Computer system 101 also includes conflict detection module 103 that can identify potential conflicts between chassis resources. Conflict detection module 103 can, for example, indicate to a user that allocating a requested chassis resource to the user would cause the requested chassis resource to conflict with one or more other chassis resources.

Sub-net 198 and sub-net 199 are each depicted as including one chassis. That is, sub-net 198 includes chassis 104 and sub-net 199 includes chassis 142. However, virtually any number of chassis can be in included in a sub-net. Vertical ellipses 191 and 192 represents that each sub-net 198 and 199 respectively can include one or more additional chassis.

Each of chassis 104 and 142 can be chassis computer systems that contain one or more blades. Within network architecture 100, each chassis is expressly depicted as including two blades. However, chassis 104 and 142 can also include one or more additional blades (not shown) or can include only a single blade. Each blade can include one or more programmable logic modules that are currently interoperating with one or more test ports to implement network diagnostic functions. For example, programmable logic module 113 can be interoperating with test ports 118 and 119 to implement a Fibre Channel network analyzer.

Chassis 104 and 142 include corresponding resource databases 106 and 143 respectively. Resources databases 106 and 143 maintain resource data representing the configuration of chassis 104 and 142 respectively, as well as blades and ports contained in chassis 104 and 142. For example, resource database 106 maintains resource data for at least chassis 104, blades 107 and 123, and test ports 118, 119, 121, 122, 134, and 136. Within blade 107, bus interface 112, control module 108, memory module 109, programmable logic module 113, and clock 114 can interoperate to cause test ports 118 and 119 to implement diagnostic functions. Similarly, bus interface 112, control module 108 memory module 111, programmable logic module 116, and clock 117 can interoperate to cause test ports 121 and 122 to implement diagnostic functions. Likewise, within blade 123, bus interface 126, control module 124, memory module 127, programmable logic module 129, and clock 131 can interoperate to cause test port 134 to implement diagnostic functions. Similarly, bus interface 126, control module 124, memory module 128, programmable logic module 132, and clock 133 can interoperate to cause test port 136 to implement diagnostic functions. Trigger ports 139 and 141 can receive TTL signals that trigger activation or deactivation of diagnostic port functionality at chassis 104.

Resource database 143 maintains resource data for at least chassis 142, blades 144 and 167, and ports 159, 161, 162, 163, and 174. Within blade 144, bus interface 158, control module 146, memory module 147, programmable logic module 151, and clock 152 can interoperate to cause test ports 159 and 161 to implement diagnostic functions. Similarly, bus interface 158, control module 146, memory module 148, programmable logic module 153, and clock 154 can interoperate to cause test ports 162 and 163 to implement diagnostic functions. Likewise, within blade 167, bus interface 169, control module 168, memory module 171, programmable logic module 172, and clock 173 can interoperate to cause test port 174 to implement diagnostic functions. Trigger ports 176 and 177 can receive TTL signals that trigger activation or deactivation of diagnostic port functionality at chassis 142.

Chassis 104 and 142 also include corresponding resource managers 192 and 194 respectively and corresponding allocation rules 191 and 195 respectively. Allocation rules can indicate combinations of chassis resources that can cause a chassis or blade to operate improprerly or combinations of chassis resources that are otherwise incompatible. For example, it may be that test ports 118 and 119 are required to operate at the same clock rate. Accordingly, allocation rules 191 can include a rule that prohibits altering the rate of clock 114 when either of test ports 118 and 119 is currently assigned to operate at a particular clock rate.

Alternately, allocation rules 191 can include a rule that allows altering a currently assigned clock rate to a new clock rate when an allocation request is received. In another example, test port 118 could be used by a user a computer system 101. The resource manager 192 could deny other users on other computer systems from gaining access or using test port 118 and other resources that are required to operate test port 118, for example, programmable logic module 113 and clock 114. This resource management could be used to avoid conflicts or interference between two or more client applications or users on the same or different computer systems.

A resource manager can refer to resource data in a resource database along with allocation rules to determine when chassis resources conflict and determine how resources are to be allocated. For example, resource manager 192 can refer to resource database 106 and allocation rules 191 to determine whether or not test port 121 can be assigned a particular personality based on the current configuration of chassis 104 and blade 107.

A requesting computer system can request resource data maintained in a resource database. This can include sending a request to a network address corresponding to the chassis, such as, for example, an IP address previously discovered by the requesting computer system. For example, computer system 101 can send a configuration request to a network address corresponding to chassis 104. Chassis 104 can respond to the configuration request by returning at least a portion of resource data contained in resource database 106 to computer system 101. A requesting computer system can also request resource data from a chassis in a different sub-net. For example, computer system 101 (in sub-net 198) can send a configuration request to chassis 142 (in sub-net 199). Chassis 142 can respond to the configuration request by returning at least a portion of resource data contained in resource database 143 to computer system 101. User-interface 102 can present received resource data at computer system 101.

Viewing Information About A Chassis, Blade, or Port

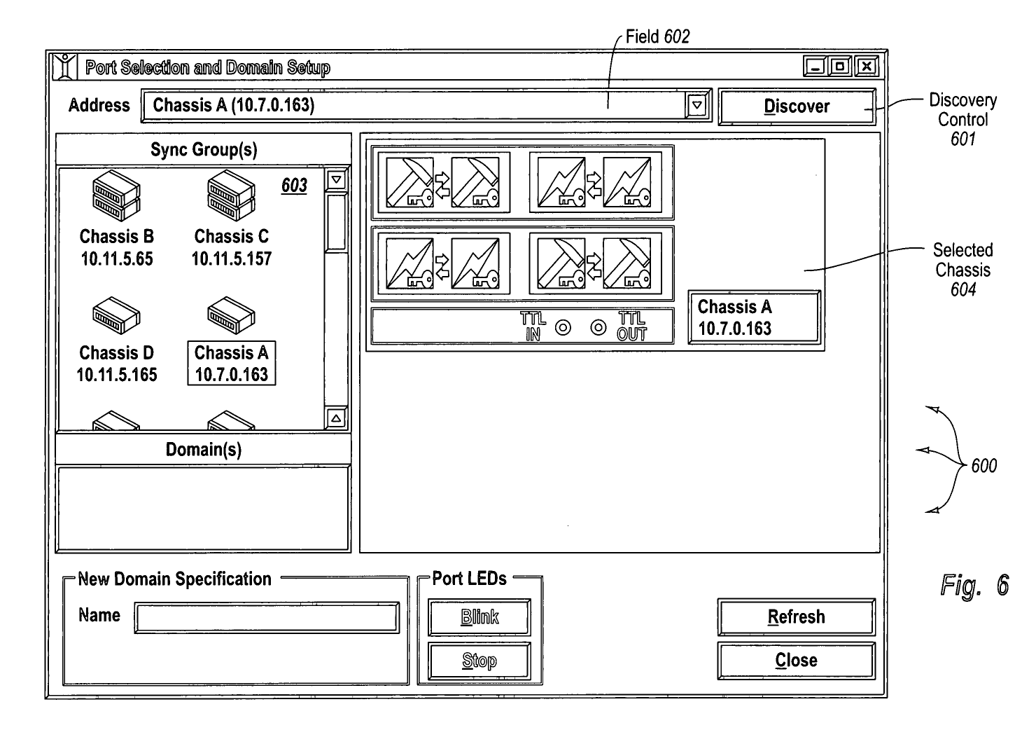

FIG. 6 illustrates an example user-interface screen 600 for presenting discovered chassis and resources. It may be that user interface 102 presents user-interface screen 600 at computer system 101. User-interface screen 600 includes discovery control 601. A user or technician can select discovery control 601 to, for example, cause a to be sent to chassis in the same or in a different sub-net from computer system 101. Thus, discovery control 601 can be utilized to discover any chassis on the local sub-net by broadcasting a message to all the chassis on the sub-net. The chassis will answer and a list of chassis can be created as the responses come back. Discovery control 601 can also be utilized to discover chassis on different sub-nets through a proxy chassis (e.g., chassis 142) located on that different sub-net. The name or IP of the proxy chassis can be entered and cached at a requesting computer system prior to utilizing the proxy chassis.

Accordingly, the discovery process for chassis on other sub-nets can include entering a name or IP address of a proxy chassis on a different subnet. For example, a user or technician can enter a proxy name or IP address into field 602. Currently and previously entered proxies are cached. Display area 603 depicts a plurality of cached proxies. Non-responsive proxies can be cleared and removed from display area 603. In the background, user-interface 119 launches discovery of all sub-nets (through cached or discovered proxies on each sub-net). For example, user-interface 102 can send a probe message to chassis 142. As depicted in display area 603, “Chassis A” is selected. Accordingly, “Chassis A” is represented in a more detailed format as selected chassis 604.

As previously described, chassis 104 and 142 have corresponding resource databases 106 and 143 respectively that maintain resource data representing the configuration of blades and ports contained in the corresponding chassis. For example, resource database 106 maintains resource data at least for blades 107 and 123 and test ports 118, 119, 121, 122, 134, and 136.

A requesting computer system can request resource data maintained in a chassis resource database. This can include sending a request to a network address corresponding to the chassis, such as, for example, an IP address previously discovered by the requesting computer system. For example, computer system 101 can send a configuration request to a network address corresponding to chassis 104 or 142. A request monitor at a chassis can respond to a request for resource data by returning at least a portion of resource data contained in corresponding resource database. For example, chassis 104 can respond to a configuration request by sending a portion of resource data contained in resource database 106 to computer system 101.

A requesting computer system can request resource data from a chassis in a different sub-net. For example, computer system 101 (in sub-net 198) can send a configuration request to chassis 142 (in sub-net 199). A corresponding request monitor can respond to the configuration request by returning a portion of resource data contained in resource database 143 to computer system 101. User-interface 102 can present received resource data at computer system 101.

Displaying and Organizing Ports

After chassis have been identified, a user-interface (e.g., user-interface 102) can be populated with resource data coming from a server on each of the chassis. The resource data can include information about the chassis itself, each of the blades, and each of the ports including status and configuration options. The user-interface can present all the chassis, blades, and ports according to specified classifications. The user-interface can also present available personalities for each programmable logic module (e.g., each FPGA), for example, based on programmable logic module type and licensing information.

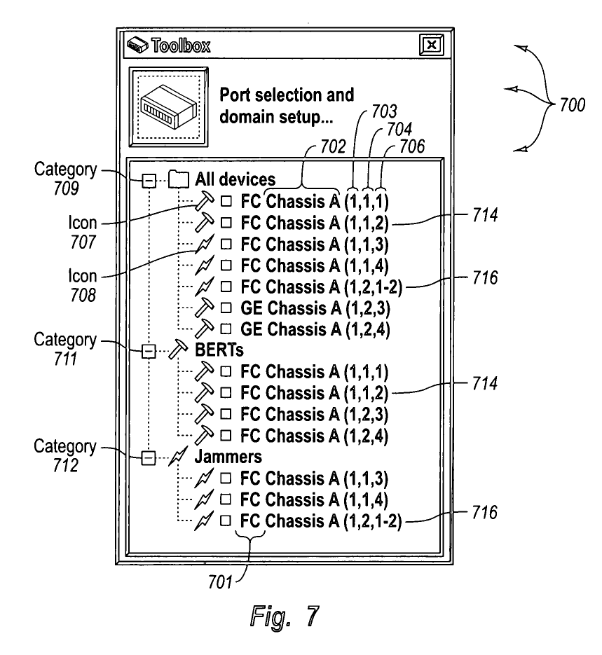

Ports can be organized in folders by type and current configuration. Since ports can belong to a plurality of categories, ports can be represented in a plurality of corresponding folders. FIG. 7 illustrates an example user-interface screen 700 for presenting organized ports. Classification of the chassis in user-interface screen 700 is divided into three categories, category 709, category 711, and category 712. However, additional categories can be included. Each category can be represented by a folder that includes one or more ports.

For example, category 709 includes all devices (e.g., discovered devices). Different icons can be utilized to represent different functionality. For example, icon 707 can be used to represent ports implementing BERTs and icon 708 can be used to represent ports implementing Jammers. Other icons can be used to represent ports implementing network analyzers, generators, and other diagnostic functions. Category 711 includes all ports implementing BERTs and category 712 includes all ports implementing Jammers.

Within each category, various information identifying a port and a corresponding configuration is displayed. Column 701 displays the protocol (e.g., Fibre Channel (“FC”), Gigabit Ethernet (“GE”), etc.) corresponding to a port. The protocol can represent the physical connector form-factor of the port. Column 702 displays the name of the chassis the port is included in. Column 703 displays the chassis number representing the chassis the port is included in. Column 704 displays the slot number of the blade the port is included in. Column 705 displays the port number of the port.

For example, entry 714 represents port 2 of a blade in slot 1 of chassis 1. Chassis 1 is named Chassis A and the represented port 1 is a Fibre Channel port. Since entry 714 represents an implemented BERT, entry 714 is included in both category 709 (“All devices”) and category 711 (“BERTs”). Entry 716 represents ports 1 and 2 of a blade in slot 2 of chassis 1. The represented ports 1 and 2 are Fibre Channel ports. Since entry 716 represents an implemented Jammer, entry 716 is included in both category 709 (“All devices”) and category 712 (“Jammers”).

Displaying More Detailed Information About A Chassis, Blade or Port

A list of ports and corresponding information can be received separate from port categories. A user-interface (e.g., user-interface 102) can present ports in a tree like control according to received categories and show corresponding port information in a separate display portion when a port is selected.

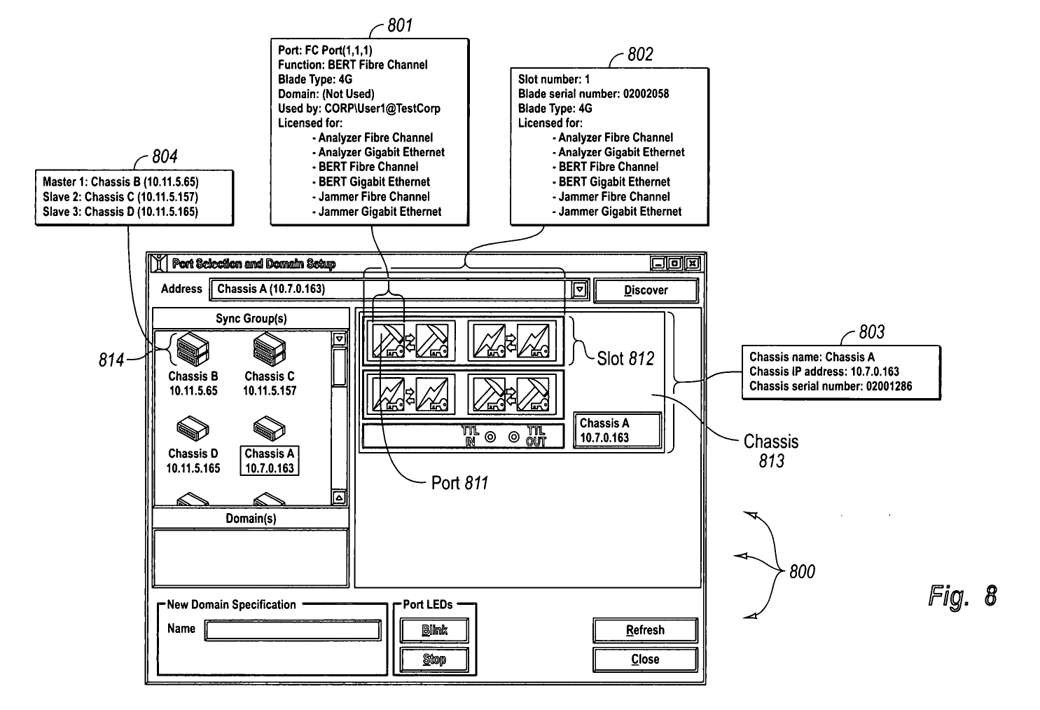

FIG. 8 depicts a first example user-interface screen 800 for presenting more detailed information for a port, slot, or chassis. More detailed information can correspond to a port, slot, chassis, synch group, or TTL port selected at user-interface screen 600. More detailed information displayed at user-interface screen 800 can include name/value pairs representing resource names and corresponding values.

For example, when port 811 is selected more detailed information 801 is displayed. When slot 812 is selected more detailed information 802 is displayed. When chassis 813 is selected more detailed information 803 is displayed. When sync group 814 is selected more detailed information 804 is displayed. Detailed information 804 indicates that Chassis B is the master (first in a daisy-chained stack of chassis) and that Chassis B1 and B2 are slaves (or other chassis in a daisy-chained stack of chassis).

User-interface 102 can select and lock subsets of ports. For example, user-interface 102 can lock test ports 159 and 161 for use as a Gigabit Ethernet jammer. User-interface 102 can also assign port personalities to a port. For example, user-interface 102 can send a command to chassis 142 that causes programmable logic module 151 to load a bit file for implementing a Gigabit Ethernet jammer at test ports 159 and 161.

Selecting And Locking A Subset Of Ports

A user-interface (e.g, user-interface 102) can be lock-aware and show the ports available for locking. Each chassis, blade, and port can be selected and subsequently locked and unlocked. When a port is locked it can be assigned a personality. It may be that a locking rule requires that each port connected (e.g, test ports 118 and 119) to the same programmable logic module (e.g., programmable logic module 133) and using the same clock (e.g., clock 114) be locked by the same client application or user. Error messages can be displayed (e.g., at user-interface 102) when a lock fails.

Assigning A Personality To A Port

Assigning a port personality can be done through the name-value table using a list of the possible values. If the personality change fails, a detailed description can be returned from the chassis. The list can be filled with the currently available, licensed, and/or authorized personalities and the user will be able to select one of them. After selection, the requesting computer system sends appropriate commands to the chassis. Accordingly, the chassis attempts to change the personality and if it can't, an appropriate explanation can be returned to the user.

The chassis can describe each port personality to the user-interface so that new personalities can be added in the future. Possible metadata about a port personality can include a name, description, port type description, resources needed, clock rate(s), protocol(s), locking rules, and sharing rules.

Within network architecture 100, user-interface 102 can interoperate with chassis 104 and chassis 142 to present resource data similar to the above listed resource data at computer system 101. Conflict detection module 103 can interoperate with resource managers 192 and 194 to indicate resource conflicts and indicate how resources are to be allocated. An indication of how resources are to be allocated can include indicating how shared resources are to be allocated. For example, resource manager 194 can indicate to conflict, detection module 103 how clock 154 is to be shared among test ports 162 and 163. Conflict detection module 103 can provide indications of resource conflicts and resource allocations to user-interface 102.

Sharing of Resources

A user-interface (user-interface 102) facilitates user access and management to the network resources. Through the user-interface, resources can be discovered, displayed, described, locked and configured. A user can interact with the user-interface to identify ports on a chassis and connect to the ports. The chassis and blade information can be provided as description. Thus, even if a user is not able to alter the configuration of a chassis or blade, the description can be useful in identifying and checking the status of the ports.

For some ports, there may be restrictions on port configurability due to hardware limitations and/or licensing restrictions. In some embodiments, there may also be limitations in the chassis, such as, for example, the number of possible synchronization domains. Restrictions can differ from blade type to blade type. For example, when there is one FPGA per port pair, assigning a personality to a port, can include loading a particular bit file in the FPGA. While the FPGA is in use by one port, the other port may be prevented from being reconfigured to a different personality than what is already loaded. Thus, the act of locking and using one port can impact what can be done with another corresponding port.

In response to user input, a conflict detection module (e.g., conflict detection module 103) can detect any resource conflicts, and present some result in response to the user input. For example, a user can request that one or more ports be configured for a specified port personality. In response to the user request, the conflict detection module can detect one or more of the following conflicts, the requested port personality is not licensed, not all the requested ports are available, not all ports can be configured as requested at this time (i.e., there is a resource conflict with current configuration), not all ports can be configured as requested (the configuration is impossible based on the given hardware. Detection module 103 can indicate any detected conflicts to user interface 102. User-interface 102 can present the results of a user request. For example, user-interface 102 can indicate a detected conflict or that the user request was successful.

Thus it may be that a detection module performs some conflict detection and a chassis performs some conflict detection. Answer delivery functions (i.e., “yes” or “no”) are flexible enough such that new answers can be added without requiring changing the user-interface. Answer delivery function flexibility is advantageous since new products can have different limitations and change the way resources are shared. For example, a user-interface may be able prevent users from selecting impossible configurations.

Protocol And Clock Rate

For blades with multiple ports per FPGA, a clock rate can be prevented from being changed for one port without making sure that it will not adversely impact the other ports. This functionality can be exposed in the user-interface to allow users to know if they can change the clock rate or indicate why they can't change the clock rate.

Changing The Clock Rate

It may be that a clock is shared between a plurality (e.g., a pair) of ports and accordingly the clock rate cannot be changed without following some rules to avoid disrupting the functionality of the ports. Thus, it may be that all (both) ports are running at the same clock rate. A user may be allowed to change a clock rate when a user is using one port and the other port or ports are unused. However, the user can be prevented from changing the clock rate if another port is in use (and thus the clock rate is locked). Clock rate values can be displayed at the user-interface.

If ports are controlled by different applications, each port can change the clock rate. The applications can lock the clock rate when it is actively used and changing it could break something. The clock rate can be unlocked when the application is in stopped mode or if the port is released. If there are no clock locks, then any application can change the clock. When the clock rate changes, the applications can be notified. Locking a plurality of ports (e.g., a port pair) to be at the same clock rate can be advantageous to reduce the likelihood of one user changing clock rate without another user knowing about the change.

TTL Ports

A user-interface (e.g., user-interface 102) can allow a user to configure TTL ports (e.g., trigger input port 139 and/or trigger output port 141) on the chassis. TTL In ports and TTL Out ports can be configured separately. Groups of ports can get triggered by the same signal line with trigger domains. Trigger domains can be utilized to propagate a signal from a TTL input port or to a TLL Output port

Trigger domains can be connected to the TTL input port or not. A feature to assign the TTL Input port to a trigger domain can be used.

In the case of the TTL Input port. No locking is required to participate in a trigger domain to listen for the trigger. Connecting the TTL Input to a trigger domain can utilize locking since not all TTL ports in the trigger domain may be interested at this new source of input triggers.

Licenses

A chassis can prevent a user from assigning a port personality for which the user does not have a license.

Other Resource Management Functionality

A user interface (e.g., user-interface 102) allows a user to select a port personality for a multi-function port. The user-interface and a conflict detection module (e.g., conflict detection module 103) can interoperate to protect resources that are being utilized from being used by other users or applications. The conflict detection module can report lock conflict data, such as, for example, a conflict type, a user that is attempting to access a resource, the host name of a computer system that is attempting to access a resource, a domain, and the age of a lock. The conflict detection module can also report other conflict data, such as, for example, hardware restrictions, licensing restrictions, application restrictions, current locks on shared resources, mandatory selection of both ports in a port pair, restrictions of sync group membership, access requirements (e.g., shared vs. exclusive). A user-interface can present data that is reported by the conflict resolution module.

Example Resources That Can Be Managed

Table 1 is an example of a possible hierarchy of blade resources that can be managed in accordance with the principles of the present invention.

| Port 1 (e.g., | Port 2 (e.g,. | Port 3 (e.g., | Port 4 (e.g,. |
|---|---|---|---|
| port 159) | port 161) | port 162) | port 163) |
| 1 SFP | 1 SFP | 1 SFP | 1 SFP |
| 4 LEDs | 4 LEDs | 4 LEDs | 4 LEDs |
| 1 Trigger Do- | 1 Trigger Do- | 1 Trigger Do- | 1 Trigger Do- |
| main Connec- | main Connec- | main Connec- | main Connec- |
| tion | tion | tion | tion |

| | |
|---|---|
| 1 FPGA (e.g., program- | 1 FPGA (e.g., program- |
| mable logic module 151 | mable logic module 153) |
| 1 Memory Module (e.g., | 1 Memory Module (e.g., |
| memory module 147) | memory module 148) |
| 1 Clock (e.g., clock 152) | 1 Clock (e.g., clock 154) |
| 1 Input and 1 Output | 1 Input and 1 Output |
| External Clock | External Clock |

PLX (e.g., control module 146)
EEPROM (e.g., control module 146)
Blade (e.g., blade 144)

Table 2 is an example of a possible hierarchy of chassis resources that can be managed in accordance with the principles of the present invention.

TABLE 2

| Blade 1 (e.g., blade | Blade 2 (e.g., blade | | |
|---|---|---|---|
| 107) | 123) | Blade 3 | Blade 4 |

1 TTL Input and 1 TTL Output (e.g., trigger ports 139 and 141)
Console Serial Port
Tap Serial Port
Box-to-box Trigger In and Trigger Out
Chassis (e.g., chassis 104)

TTL In and TTL Out can be connected to different domains or to multiple ones in the same time.

Table 3 is an example of a possible hierarchy of resources of inter-connected chassis that can be managed in accordance with the principles of the present invention.

TABLE 3
8 Trigger Domains

| Chassis 1 | Chassis 2 | Chassis 3 | Chassis 4 | Chassis 5 | Chassis 6 | ... | Chassis N |
|---|---|---|---|---|---|---|---|
| (e.g., | (e.g., | | | | | | |
| chasses | chasses | | | | | | |
| 104) | 142) | | | | | | |

In some embodiments, a master chassis controls one or more other chassis in a chain of chassis. A trigger domain of one chassis can trigger the same domain in one or more other chassis.

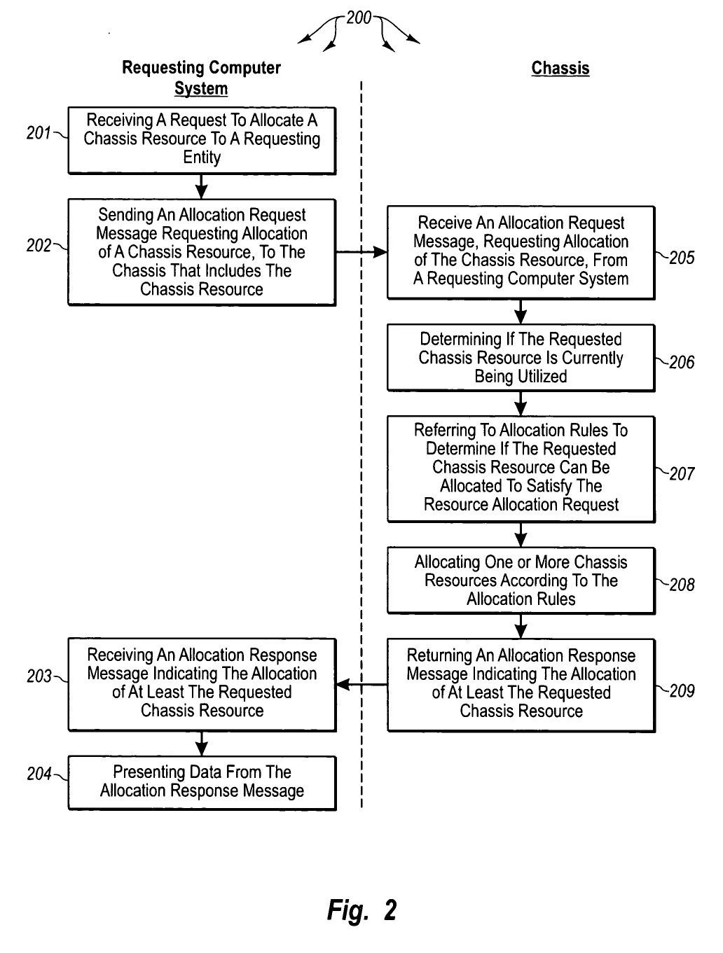

FIG. 2 illustrates a flowchart of a method 200 for managing resources of chassis that include network diagnostic modules in accordance with the principles of the present invention. The method 200 will be discussed with respect to the modules and data structures depicted in network architecture 100. The method 200 includes an act of receiving a request to allocate a chassis resource to a requesting entity (act 201). Act 201 can include a requesting computer system receiving a request to allocate a chassis resource to a requesting entity. For example, computer system 101 can receive a request to allocate a chassis resource as a result of user manipulation of an input device (e.g., a keyboard or mouse). An input device can be coupled to computer system 101 or can be coupled to a computer system that is network connectable to computer system 101. Alternately, computer system 101 can receive an automated request (e.g., an electronic message) to allocate a chassis resource. An automated request to allocate a chassis resource can originate at a module of computer system 101 or at another computer system that is network connectable to computer system 101. An automated request to allocate a chassis resource can be generated in response to the occurrence of an event, such as, for example, the expiration of a timer or execution of a script.

A chassis resource can be, for example, a trigger input port, a trigger output port, a clock, a test port, or a blade. For example, a user of computer system 101 (or other network connectable computer system) can request that test port 121 (e.g., as selected from user-interface 102) be allocated to function as a generator. A received request can include a request that a test port or test ports be configured in accordance with a specified personality (e.g., a request to configure test ports 159 and 161 as a Gigabit Ethernet network analyzer operating at 1.25 Gbps).

The method 200 includes an act of sending an allocation request message, requesting allocation of the chassis resource, to the chassis that includes the chassis resource (act 202). Act 202 can include a requesting computer system sending an allocation request message, requesting allocation of the chassis resource, to the chassis that includes the chassis resource. For example, computer system 101 can send allocation request 181 to chassis 104. In some embodiments, a requesting computer system sends an allocation request message to a chassis in a different sub-net. For example, computer system 101 can send allocation request 183 to chassis 142. Thus, a requesting computer system and a chassis can be connected to different portions of a LAN, WAN, or even the Internet. An allocation request message can include appropriate instructions and/or commands for identifying a resource and, when the resource is a test port, a personality. An allocation request message can be sent a network address (e.g., an IP address) corresponding to a chassis.

The method 200 includes an act of receiving an allocation request message, requesting allocation of the chassis resource, from a requesting computer system (act 205). Act 205 can include a chassis receiving an allocation request message, requesting allocation of the cassis resource, from a requesting computer system. For example, chassis 104 can receive allocation request 181 from computer system 101. Similarly, chassis 142 can receive allocation request 183 from computer system 101.

The method 200 includes an act of determining if the requested chassis resource is currently being utilized (act 206). Act 206 can include a chassis determining if the requested chassis resource is currently being utilized. For example, resource manager 192 can determine if a resource of chassis 104 (as requested in allocation request 181) is currently being utilized. Similarly, resource manager 194 can determine if a resource of chassis 142 (as requested in allocation request 183) is currently being utilized. Determining if a resource is currently allocated can include identifying the current personality of a test port. For example, resource manager 192 can refer to resource database 106 to identify that test port 122 is currently configured as an SONET bit error rate tester operating at 10 Gbps.

The method 200 includes an act of referring to allocation rules to determine if the requested chassis resource can be allocated to satisfy the resource request (act 207). Act 207 can include a chassis referring to allocation rules to determine if the requested chassis resource can be allocated to satisfy the resource request. For example, resource manager 192 can refer to allocation rules 191 to determine if a resource of chassis 104 can be allocated to satisfy allocation request 181. Similarly, resource manager 194 can refer to allocation rules 195 to determine if a resource of chassis 142 can be allocated to satisfy allocation request 183.

Referring to allocation rules can include referring to rules that identify how shared resources can be allocated. For example, when test port 162 is configured according to a specified personality, allocation rules 195 can identify configurations of test port 163 that are compatible (or incompatible) with the specified personality. In some embodiments, the configuration of a test port that shares a clock with one or more other test ports is limited to the clock speed currently allocated to the one or more other test post. For example, when test port 118 is currently configured to operate at a clock rate compatible with data transfer at 1.065 Gbps, test ports 119 may be restricted to also operating at the same clock rate. Alternately, allocation rules can indicate that more recent allocation requests override existing resource allocations. For example, a request to configure test port 118 for data transfer at 2.5 Gbps can override a current clock rate for compatible data transfer at 1.065 Gbps (either at test port 119).

In some embodiments, a conflict manager (e.g., conflict manager 103) and a resource manager (e.g., resource manager 192) interoperate to determine if a requested port is available and can be allocated. For example, it can be determined if hardware is compatible for implementing a requested behavior, protocol, and clock rate at the requested port. If hardware is not compatible with a requested behavior, protocol, or clock rate the port is not allocated. It can also be determined if a user is licensed to implement requested behavior, protocol, and clock rate for the requested port. If a user is not licensed the requested port is not allocated. It can also be determined if the requested port is locked by another user. If the requested port is locked it is not allocated. It can also be determined if the requested port is part of a port pair and if the other port of the port pair is in use. If the other port of the port pair is in use, the port is allocated with possible restrictions (e.g., changing clock rate and/or protocol is prevented) or is not allocated.

The method 200 includes an act of allocating one or more chassis resources according to the allocation rules (act 208). Act 208 can include a chassis allocating one or more chassis resources according to the allocation rules. For example, resource manager 192 can allocate the resources of chassis 104 according to allocation rules 191. Similarly, resource manager 194 can allocate the resources of chassis 142 according to allocation rules 195. It may be that a chassis resource is allocated to satisfy an allocation request and also remains allocated to previous requests. For example, when clock 152 is currently allocated to implement a 2.125 Gbps generator at test port 159, clock 152 can be further allocated to satisfy an allocation request for a 2.125 Gbps bit error rate tester at test port 161.

When a port is allocated for a specified port personality, the port can be locked such that other applications do not disrupt the port personality. Locking a port can include locking both ports of a port pair.

The method 200 includes an act of returning an allocation response message indicating the allocation of at least the requested chassis resource (act 209). Act 209 can include a chassis returning an allocation response message indicating the allocation of at least the requested chassis resource. For example, chassis 104 can return allocation response 182 to computer system 101. A chassis can return an allocation response message to a requesting computer system in a different sub-net. For example, chassis 142 (in sub-net 199) can return allocation response 184 to computer system 101 (in sub-net 198). A chassis can return an allocation response message to a network address (e.g., an IP address) corresponding to the requesting computer system.

An allocation response message can indicate whether or not the requested resources were allocated according to an allocation request. When the resource is allocated in accordance with an allocation request message, an allocation response message can include an indication that the allocation request was successful. On the other hand, when the resource is not allocated in accordance with the allocation request message, the allocation response message can include information indicating why the allocation request was not satisfied (e.g., a requested resource was already in use or a requested resource could not be allocated in a manner that was compatible with existing resource allocations). An allocation response message can also include an indication of any previous resource allocations that were overridden. A chassis may send additional messages to users that have had their allocations overridden.

The method 200 includes an act of receiving an allocation response message indicating the allocation of at least the requested chassis resource (act 203). Act 203 can include a requesting computer system receiving an allocation response message indicating the allocation of at least the requested chassis resource. For example, computer system 101 can receive allocation response 182 from chassis 104. A requesting computer system can also receive allocation responses from chassis in different sub-nets. For example, computer system 101 (in sub-net 198) can receive allocation response 184 from chassis 142 (in sub-net 198).

The method 200 includes an act of presenting data from the allocation response message (act 204). Act 204 can include requesting computer system presenting data from the allocation response message. For example, user-interface 102 can present data from allocation response 182 at computer system 101. Similarly, user-interface 102 can present data from allocation response 184 at computer system 101. Accordingly, messages indicating successful allocation of a chassis resource and/or messages providing information as to why a chassis resource could not be allocated can be presented to a user.

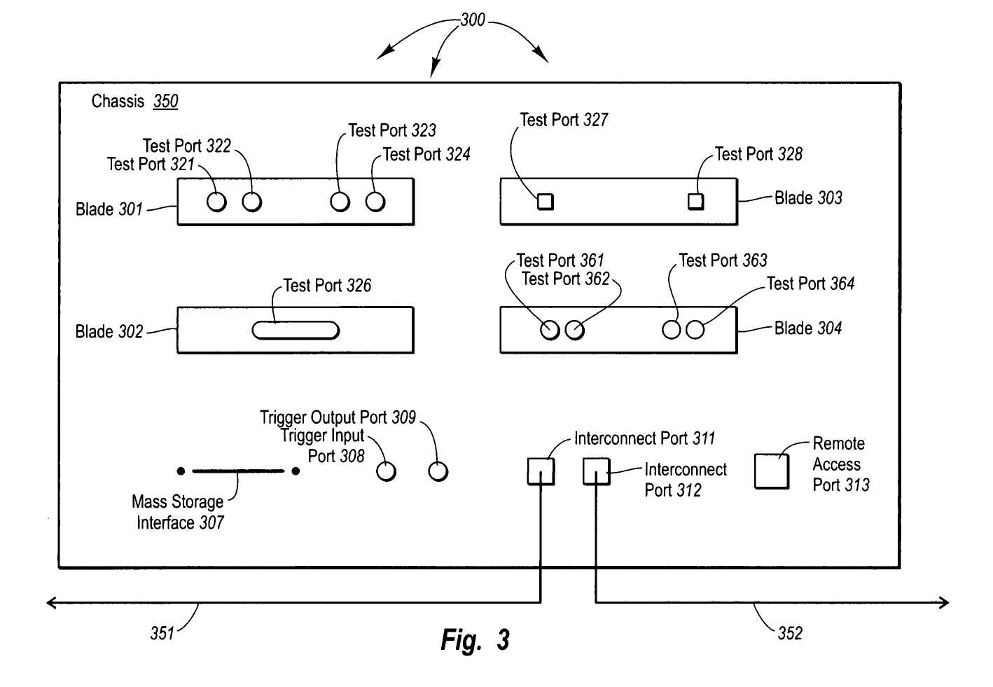

FIG. 3 illustrates an example computer system architecture 300 including a plurality of network diagnostic modules in accordance with the principles of the present invention. Depicted in computer system architecture 300 is chassis 350, which includes blades 301, 302, 303, and 304. Although not expressly depicted, each of blades 301, 302, 303, and 304 are coupled, through an appropriate bus interface, to a computer system bus of chassis 350. For example, each of blades 301, 302, 303, and 304 can include PCI bus interfaces that are inserted into PCI receptacles at chassis 350. Accordingly, computer-executable instructions, computer-interpretable instructions, or circuit design data can be transferred over the computer system bus to blades 301, 302, 303, and 304 to configure and re-configure corresponding test ports.

Blades coupled to a chassis can have different numbers and configurations of test ports. For example, depicted at blade 301 test ports 321, 322, 323 and 324 can each be SFP ports. Depicted at blade 303 test ports 327 and 328 can be XFP ports. Depicted at blade 302 test port 326 can be an XBI port. Depicted at blade 304 test ports 361, 362, 363, and 364 can be SFP ports. Accordingly, the test ports of chassis 350 can be simultaneously connected to the same or a variety of different networks, such as, for example, 10 Gigabit Ethernet, 100 Megabit Ethernet, Infiniband, and SONET networks, to implement the same or a variety of different network diagnostic functions.

Mass storage interface 307 can be an interface for coupling to mass storage devices. For example, mass storage interface 307 may be a Small Computer System Interface (“SCSI”) that is coupled to a SCSI hard drive. Accordingly, as network diagnostic data is collected at blades 301, 302, 303, and 304, the network diagnostic data can be transferred to the SCSI hard drive for storage.

Interconnect ports 311 and 312 (e.g., RJ-45 ports) can be utilized to connect chassis 350 to other chassis (not shown). Connections from chassis 350 to other chassis, for example, as illustrated by links 351 and 352, can be utilized to transfer control signals that coordinate the collection of network diagnostic data. For example, the collection of network diagnostic data for a network analyzer implemented in blade 304 can be coordinated with the collection of network diagnostic data for a bit error rate tester implemented at another chassis coupled to link 351. Accordingly, through the exchange of control signals, it may be that test ports at a plurality of different chassis are configured to implement network diagnostic functions in a coordinated manner.

Trigger input port 308 and trigger output port 309 (e.g., TTL ports) can be utilized to transfer trigger signals to and from chassis 350. Generally, trigger signals can indicate the occurrence of an event to a chassis. In response to the occurrence of an event, a chassis can activate or deactivate network diagnostic functionality. For example, it may be that a programmable logic module controlling test port 326 is implementing a bit error rate tester. However, it may be desirable to activate bit error rate testing of a network coupled to port 326 only when a particular computer system is transmitting data onto the network. An appropriate mechanism for detecting when the particular computer system is transmitting data can be utilized to generate a trigger signal.

When a trigger signal is received at trigger input port 308, bit error rate testing through port test 326 can be activated or deactivated. In some embodiments, for example, when a plurality of chassis are connected, trigger inputs and outputs of different chassis can be coupled together so that the chassis receive the same triggers. For example, trigger input port 308 can be coupled to a trigger output port of a chassis connected to link 351 and/or trigger output port 309 can be coupled to a trigger input port of a chassis connected to link 352. Accordingly, when test ports at a plurality of different chassis are configured to perform coordinated network diagnostic functions, the network diagnostic functions can be activated and deactivated in response to the same events.

Remote access port 313 (e.g., an RJ-45 port) can be utilized to remotely configure chassis 350. Through remote access port 313, chassis 350 can be coupled to a network, such as, for example, a Local Area Network (“LAN”) or Wide Area Network (“WAN”), along with one or more other computer systems. The other computer systems can utilize the network to access configuration information from chassis 350. The other computer systems can also initiate configuration requests to configure or re-configure ports included in chassis 350. Accordingly, an administrator or user at a remote computer system can configure the test ports of chassis 350 (as well as configuring test ports at other chassis connected to the network) to implement selected network diagnostic functions.

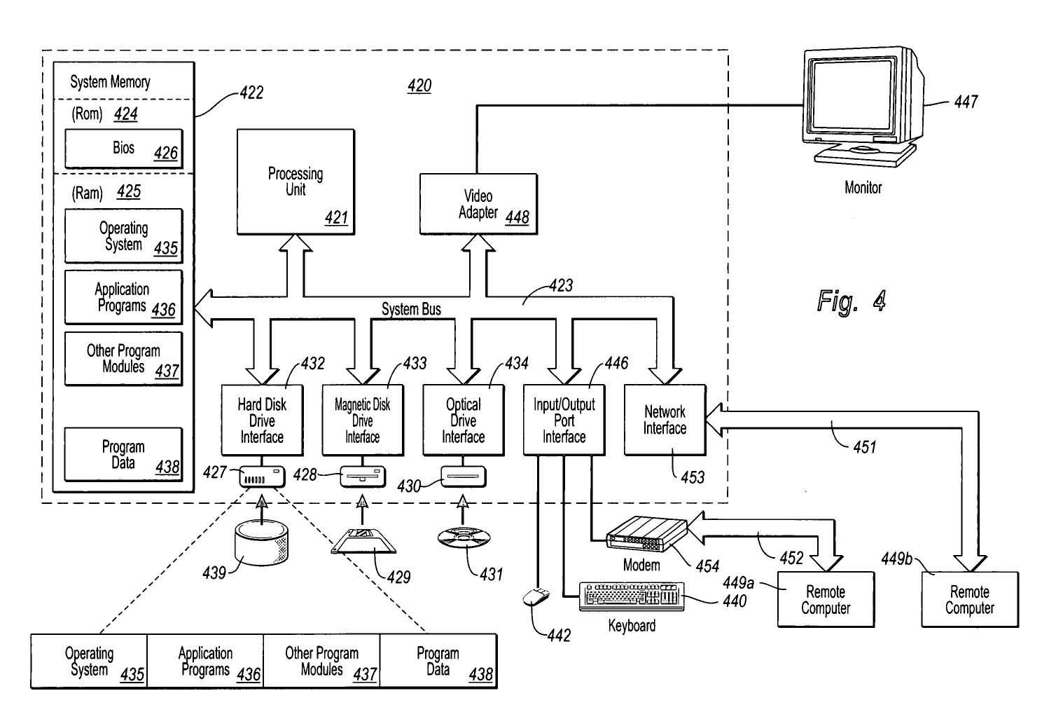

FIG. 4 illustrates a suitable operating environment for the principles of the present invention. FIG. 4 and the following discussion are intended to provide a brief, general description of a suitable computing environment in which the invention may be implemented. With reference to FIG. 4, an example system for implementing the invention includes a general-purpose computing device in the form of computer system 420.

Computer system 420 includes a processing unit 421, a system memory 422, and a system bus 423 that couples various system components including the system memory 422 to the processing unit 421. Processing unit 421 can execute computer-executable instructions designed to implement features of computer system 420, including features of the present invention. The system bus 423 may be any of several types of bus structures including a memory bus or memory controller, a PCI bus, a peripheral bus, and a local bus using any of a variety of bus architectures. Computer system 420 can include one or more receptacles for receiving print circuit boards or “cards” that interface with system bus 423. System memory 422 includes read only memory (“ROM”) 424 and random access memory (“RAM”) 425. A basic input/output system (“BIOS”) 426, containing the basic routines that help transfer information between elements within the computer 420, such as during start-up, may be stored in ROM 424.

The computer system 420 may also include a magnetic hard disk drive 427 (e.g., a SCSI drive) for reading from and writing to a magnetic hard disk 439, a magnetic disk drive 428 for reading from or writing to a removable magnetic disk 429, and an optical disk drive 430 for reading from or writing to removable optical disk 431, such as, or example, a CD-ROM or other optical media. The magnetic hard disk drive 427, magnetic disk drive 428, and optical disk drive 430 are connected to the system bus 423 by hard disk drive interface 432, magnetic disk drive-interface 433, and optical drive interface 434, respectively. The drives and their associated computer-readable media provide nonvolatile storage of computer-executable instructions, data structures, program modules, and other data for computer system 420. Although the example environment described herein employs a magnetic hard disk 439, a removable magnetic disk 429 and a removable optical disk 431, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 439, magnetic disk 429, optical disk 431, ROM 424 or RAM 425, including an operating system 435, one or more application programs 436, other program modules 437 (e.g., bit files), and program data 438. A user may enter commands and information into the computer system 420 through keyboard 440, pointing device 442, or other input devices (not shown), such as, for example, a microphone, joy stick, game pad, scanner, or the like. These and other input devices can be connected to the processing unit 421 through input/output interface 446 coupled to system bus 423. Alternatively, input devices can be connected by other interfaces, such as, for example, a parallel port, a game port, a universal serial bus (“USB”) port, or a Fire Wire port. A monitor 447 or other display device is also connected to system bus 423 via video adapter 448. Computer system 420 can also be connected to other peripheral output devices (not shown), such as, for example, speakers and printers.

Computer system 420 is connectable to networks, such as, for example, an office-wide or enterprise-wide computer network, an intranet, and/or the Internet. Computer system 420 can exchange data with external sources, such as, for example, remote computer systems, computer system chassis containing network diagnostic modules, remote applications, and/or remote databases over such a network.

Computer system 420 includes network interface 453, through which computer system 420 receives data from external sources and/or transmits data to external sources. As depicted in FIG. 4, network interface 453 facilitates the exchange of data with remote computer system 449b via link 451. Link 451 represents a portion of a network, and remote computer system 449b represents a node of the network.

Likewise, computer system 420 includes input/output interface 446, through which computer system 420 receives data from external sources and/or transmits data to external sources. Input/output interface 446 is coupled to modem 454, through which computer system 420 receives data from and/or transmits data to external sources. Alternately, modem 454 can be a Data Over Cable Service Interface Specification (“DOCSIS”) modem or digital subscriber lines (“DSL”) modem that is connected to computer system 420 through an appropriate interface. However, as depicted in FIG. 4, input/output interface 446 and modem 454 facilitate the exchange of data with remote computer system 449a via link 452. Link 452 represents a portion of a network, and remote computer system 449a represents a node of the network.

While FIG. 4 represents a suitable operating environment for the present invention, the principles of the present invention may be employed in any system that is capable of, with suitable modification if necessary, implementing the principles of the present invention. The environment illustrated in FIG. 4 is illustrative only and by no means represents even a small portion of the wide variety of environments in which the principles of the present invention may be implemented.

Modules of the present invention, as well as associated data, can be stored and accessed from any of the computer-readable media associated with computer system 420. For example, portions of such modules and portions of associated program data may be included in operating system 435, application programs 436, program modules 437 and/or program data 438, for storage in system memory 422. When a mass storage device, such as, for example, magnetic hard disk 439, is coupled to computer system 420, such modules and associated program data may also be stored in the mass storage device. In a networked environment, program modules and associated data depicted relative to computer system 420, or portions thereof, can be stored in remote memory storage devices, such as, for example, system memory and/or mass storage devices associated with remote computer system 449b and/or remote computer system 449a. Execution of such modules may be performed in a distributed manner.

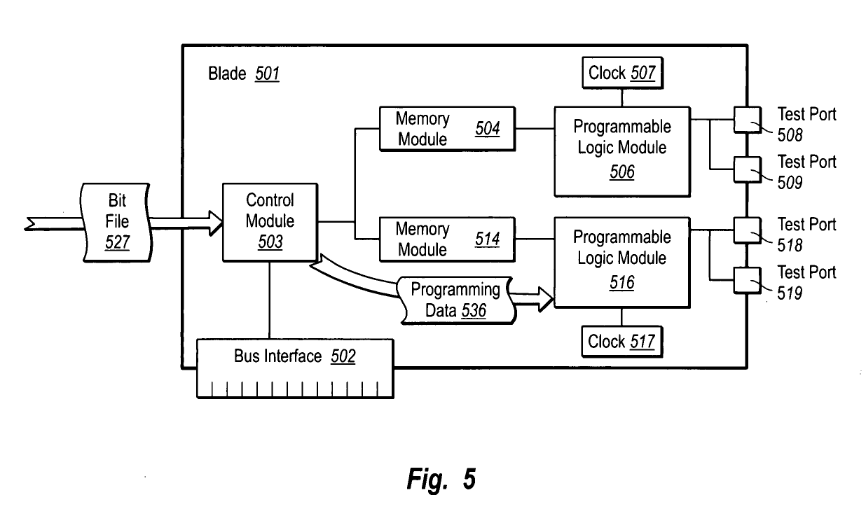

FIG. 5 illustrates an example of a network diagnostic module and test ports that can interoperate to implement a network diagnostic function. The network diagnostic module and test ports are implemented in blade 501, which can be a printed circuit board. Bus interface 502 can be inserted into an appropriate receptacle (e.g., a Peripheral Component Interconnect (“PCI”) interface) at a computer system to communicatively couple blade 501 to the computer system. Blade 501 can communicate (e.g., sending and receiving appropriate electrical signaling) with a corresponding computer system bus (e.g., a PCI bus) through bus interface 502.

Blade 501 includes memory 504 and programmable logic module 506 that control the functionality of test ports 508 and 509. Memory 504 can be any of a variety of different types of memory, such as, for example, Random Access Memory (“RAM”). Memory 504 can be used by programmable logic module 506 in its operation (e.g., to receive or transmit network data or store other information and to buffer data that is transferred between programmable logic module 506 and control module 503. Programmable logic module 506 can be virtually any type of programmable circuit, such as, for example, a Field-Programmable Gate Array (“FPGA”), Programmable Logic Array (“PLA”), or other type programmable logic device. Programmable logic module 506 can include circuitry form implementing any of a plurality of network diagnostic functions (e.g., network analyzer, jammer, generator, or bit error rate tester, etc).

It may be that a network diagnostic function is part of a port personality represented in a bit file. For example, a port personality can include a network diagnostic function, a speed (e.g., 1.0625, 2.125, or 2.5 Gigabits per second), and a protocol (e.g., Fibre Channel, Gigabit Ethernet, Infiniband, etc). Accordingly, programmable logic module 106 can process computer-executable instructions, computer-interpretable instructions, or circuit design data, to cause programmable logic module 506 and test port 508 and/or test port 509 to interoperate to implement a port personality in accordance with the processed computer-executable instructions, computer-interpretable instructions, or circuit design data. For example, programmable logic module 506 can process instructions from a bit file to cause programmable logic module 506 and test ports 508 and test port 509 to interoperate to implement a Fibre Channel jammer at 2.125 Gbps. Accordingly, the personality of test port 508 and the personality of test port 509 can include implementation of a particular network diagnostic function.

It may that a plurality of test ports are utilized together to implement a particular network diagnostic function. For example, test ports 508 and 509 can be utilized together to implement a network analyzer. On the other hand, it may be a first test port is utilized to implement a first network diagnostic function, while a second different test port is simultaneously utilized to implement a second different network diagnostic function. For example, test port 508 can be utilized to implement a generator, while test port 509 is simultaneously utilized to implement a bit error rate tester. A bit file having appropriate instructions can be loaded at a programmable logic module 506 to cause test port 508 and test port 509 to simultaneously implement different network diagnostic functions. Clock 507 can coordinate the appropriate timing of data transferred to and from test port 508 and test port 509.

Blade 501 also includes memory 514 and programmable logic module 516 that control the functionality of test ports 518 and 519. Similar to memory 504, memory 514 can be any of a variety of different types of memory, such as, for example, Random Access Memory (“RAM”). Memory 514 can be used by programmable logic module 516 in its operation (e.g., to receive or transmit network data or store other information) and to buffer data that is transferred between programmable logic module 516 and control module 503. Similar to programmable logic module 506, programmable logic module 516 can be virtually any type of programmable circuit, such as, for example, a Field-Programmable Gate Array (“FPGA”), Programmable Logic Array (“PLA”), or other type programmable logic device. Similar to programmable logic module 506, programmable logic module 516 can include circuitry form implementing any of a plurality of network diagnostic functions (e.g., network analyzer, jammer, generator, or bit error rate tester, etc). Although not required, it may be that programmable module 506 and programmable logic module 516 are the same type of programmable logic module.

Similar to programmable logic module 506, programmable logic module 516 can process computer-executable, instructions, computer-interpretable instructions, or circuit design data (e.g., programming data 536) to cause programmable logic module 516 and test port 518 and/or test port 519 to interoperate to implement a port personality (including network diagnostic function, clock rate, and protocol) in accordance with the processed computer-executable, computer-interpretable instructions, or circuit design data. Test ports 518 and 519 can be utilized together to implement a particular network diagnostic function. On the other hand, test port 518 may be utilized to implement a first network diagnostic function, while test port 519 is utilize to implement a second different network diagnostic function.

For example, programmable logic module 516 can process instructions from a bit file (e.g., bit file 527) to cause programmable logic module 516 and test ports 518 to interoperate to implement a Fibre Channel bit error rate test at 2.125 Gbps and to cause programmable logic module 516 and test ports 518 and 519 to interoperate to implement a Fibre Channel generator at 1.0625 Gbps. A bit file having appropriate instructions can be loaded at programmable logic module 516 to cause test port 518 and test port 519 to simultaneously implement different network diagnostic functions. Clock 517 can coordinate the appropriate timing of data transferred to and from test port 518 and test port 519.

Test ports of different programmable logic modules can be configured to implement the same personalities. For example, programmable logic module 506 may process instructions that that cause test ports 508 and 509 to implement a Gigabit Ethernet analyzer at 1.25 Gbps, while programmable logic module 516 also processes instructions that cause test ports 518 and 519 to implement a Gigabit Ethernet analyzer at 1.065 Gbps. On the hand, test ports of different programmable logic modules can be configured to implement different personalities. For example, programmable logic module 506 may process instructions that that cause test ports 508 and 509 to implement a Fibre Channel analyzer at 1.0625 Gbps, while programmable logic module 516 processes instructions that cause test ports 518 and 519 to implement an Gigabit Ethernet Jammer at 1.25 Gbps.

Test ports 508, 509, 518 and 519 can be of virtually any physical configuration, such as, for example, RJ-11, RJ-45, small form-factor pluggable (“SFP”), Universal Serial Bus (“USB”), IEEE 1394 (Firewire), XBI, a XENPAK (70-pin configuration), etc. Test ports 508, 509, 518 and 519 can also be physically configured to receive virtually any type of cabling, such as, for example, cabling that carries electrical signals or carries optical signals. Test ports 508, 509, 518 and 519 can be configured to receive connectors that facilitate communication using any of a variety of protocols, including Serial Attached SCSI (“SAS”) and Serial ATA (“SATA”) protocols. Although not required, it may be that ports controlled by the same programmable logic module are configured as the same type of port. For example, test ports 508 and 509 (both controlled by programmable logic module 506) may both be SFP ports configured to receive optical cable.

Control module 503 coordinates the transfer of data between bus interface 502 and memories 504 and 514. Control module 503 can translate data received from bus interface 502 (e.g., a PCI interface) into a format that can be processed by programmable logic modules included in blade 501. Likewise, control module 503 can translate data received from a programmable logic module into a format that can be compatibly transferred over a computer system bus (e.g., a PCI bus) that is communicatively coupled to bus interface 502. Based on received data (e.g., appropriate addressing information), control module 503 can also identify the programmable logic module that is associated with the received data. Accordingly, control module 503 can transfer at least a portion of the received data (e.g., computer-executable instructions, computer-interpretable instructions, or circuit design data) to the associated programmable logic module.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

1. In a requesting computer system that is network connectable to one or more chassis that each include one or more network diagnostic modules, a method for managing the resources of a chassis, the method comprising the acts of:
receiving a request to allocate a chassis resource to a requesting entity;
sending an allocation request message to a chassis that includes the chassis resource, the allocation request message requesting allocation of the chassis resource;
receiving an allocation response from the chassis, the allocation response indicating the allocation of at least the requested chassis resource; and
presenting the allocation response at the requesting computer system.

2. The method as recited in claim 1, wherein the act of receiving a request to allocate a chassis resource comprises an act of receiving input at an input device.

3. The method as recited in claim 1, wherein the act of receiving a request to allocate a chassis resource comprises an act of receiving a message from another computer system that is network connectable to the requesting computer system.

4. The method as recited in claim 1, wherein the act of receiving a request to allocate a chassis resource comprises an act of a receiving a request to allocate a port for implementing a network diagnostic function.

5. The method as recited in claim 4, wherein the act of receiving a request to allocate a port for implementing a network diagnostic function comprises an act of receiving a request to implement a port personality at the port.

6. The method as recited in claim 5, wherein the act of receiving a request to implement a port personality at the port comprises an act of receiving a request to implement a selected protocol at the port, wherein the selected protocol being is selected from among the following protocols: Fibre Channel, Gigabit Ethernet, Serial Attached SCSI, Serial ATA Infiniband, and SONET.

7. The method as recited in claim 5, wherein the act of receiving a request to implement a port personality at the port comprises an act of receiving a request to implement a selected clock rate at the port, wherein the selected clock rate is selected from among the following clock rates: 1.065 Gbps, 1.25 Gbps, 1.5 Gbps, 2.125 Gbps, 2.5 Gbps, 3 Gbps, 4.25 Gbps, 6 Gbps, 8.5 Gbps and 10.3125 Gbps, 10.51875 Gbps.

8. The method as recited in claim 1, wherein the act of receiving a request to allocate a chassis resource comprises an act of a request to allocate a TTL port.

9. The method as recited in claim 1, wherein sending an allocation request message comprises an act of sending commands that request a port to be configured in accordance with a port personality.

10. The method as recited in claim 1, wherein sending an allocation request message comprises an act of sending an allocation request to a chassis that is in a different sub-net than the requesting computer system.

11. The method as recited in claim 1, wherein sending an allocation request message comprises an act of sending an allocation request to a network address corresponding to the chassis that includes the requested resource.

12. The method as recited in claim 1, wherein receiving an allocation response comprises an act of receiving an indication that the requested chassis was allocated in accordance with the allocation request.

13. The method as recited in claim 1, wherein receiving an allocation response comprises an act of receiving information indicating why the requested resource could not be allocated in accordance with the allocation request.

14. The method as recited in claim 1, wherein receiving an allocation response comprises an act of receiving an allocation response from a chassis that is a different sub-net than the requesting computer system.

15. The method as recited in claim 1, wherein presenting the allocation response at the requesting computer system comprises an act of presenting information associated with the allocation of the requested resource.

16. The method as recited in claim 1, further comprising:
an act of determining if allocating the requested resource according to the allocation request would cause the requested resource to conflict with other resources.

17. In a chassis that includes one or more network diagnostic modules and that is network connectable to a requesting computer system, a method for managing the resources of the chassis, the method comprising the acts of:
receiving an allocation request message from the requesting computer system, the allocation request message requesting allocation of a chassis resource;
determining if the requested chassis resource is currently being utilized;
referring to allocation rules to determine if the requested chassis resource can be allocated to satisfy the resource allocation request;
allocating one or more chassis resources according to the allocation rules; and
returning an allocation response to the requesting computer system, the allocation response indicating the allocation of at least the requested resource.

18. The method as recited in claim 17, wherein the act of receiving an allocation request message from the requesting computer system comprises an act of receiving an allocation request message that requests allocation of a port for implementing a network diagnostic function.

19. The method as recited in claim 17, wherein the act of receiving an allocation request message from the requesting computer system comprises an act of receiving commands that request a port be allocated to implement a selected port personality.

20. The method as recited in claim 19, wherein the act of receiving commands that request a port be allocated to implement a selected port personality comprise an act of receiving commands that request the port be allocated to implement a selected protocol at the port, wherein the selected protocol being is selected from among the following protocols: Fibre Channel, Gigabit Ethernet, Infiniband, Serial Attached SCSI, Serial ATA, and SONET.

21. The method as recited in claim 19, wherein the act of receiving commands that request a port be allocated to implement a selected port personality comprise an act of receiving commands that request the port be allocated to implement a selected clock rate at the port, wherein the selected clock rate is selected from among the following clock rates: 1.065 Gbps, 1.25 Gbps, 1.5 Gbps, 2.125 Gbps, 2.5 Gbps, 3 Gbps, 4.25 Gbps, 6 Gbps, 8.5 Gbps and 10.3125 Gbps, 10.51875 Gbps.

22. The method as recited in claim 17, wherein the act of receiving an allocation request message from the requesting computer system comprises an act of receiving an allocation message from a sub-net that is different from the sub-net including the chassis.

23. The method as recited in claim 17, wherein the act of referring to allocation rules comprises an act of referring to allocation rules that indicate the current allocation of the requested chassis resource can be overwritten.

24. The method as recited in claim 17, wherein the act of referring to allocation rules comprises an act of referring to locking rules that indicate whether or not the requested resource can be locked according to the allocation request message.

25. The method as recited in claim 17, wherein the act of referring to allocation rules comprises an act of referring to sharing rules that indicate whether or not the requested resource can be shared with other resources according to the allocation request message.

26. The method as recited in claim 13, wherein the act of referring to allocation rules comprises an act of referring to allocation rules that indicate the requested chassis resource can be allocated to satisfy the allocation request.

27. The method as recited in claim 28, wherein the act referring to allocation rules that indicate the requested chassis resource can be allocated to satisfy the allocation request comprises an act of referring to rules that indicate the requested chassis resource can be shared.

28. The method as recited in claim 17, wherein the act of allocating one or more chassis resources according to the allocation rules comprises an act of maintaining a current resource allocation

29. The method as recited in claim 17, wherein the act of allocating one or more chassis resources according to the allocation rules comprises an act of allocating an unused chassis resource to satisfy the request for allocation of a chassis resource.

30. The method as recited in claim 17, wherein the act of allocating one or more chassis resources according to the allocation rules comprises an act of allocating a chassis resource that is already in use to satisfy the request for allocation of a chassis resource.

31. The method as recited in claim 17, wherein the act of allocating one or more chassis resources according to the allocation rules comprises an act of configuring a port personality according to the allocation request message.

32. The method as recited in claim 17, wherein the act of returning an allocation response to the requesting computer system comprises an act of returning an indication that the requested chassis was allocated in accordance with the allocation request.

33. The method as recited in claim 17, wherein the act of returning an allocation response to the requesting computer system comprises an act of returning information indicating why the requested resource could not be allocated in accordance with the allocation request message.

34. The method as recited in claim 17, wherein the act of returning an allocation response to the requesting computer system comprises an act of returning an allocation response to sub-net that is different than the sub-net including the chassis.

35. The method as recited in claim 17, wherein the act of returning an allocation response to the requesting computer system comprises an act of returning an allocation response to a network address corresponding to the requesting computer system.

36. A computer program product for use in a requesting computer system that is network connectable to one or more chassis that each include one or more network diagnostic modules, the computer program product for implementing a method for managing the resources of a chassis, the computer program product comprising one or more computer-readable media having stored thereon computer-executable instructions that, when executed by a processor, cause the requesting computer system to perform the following:
receive a request to allocate a chassis resource to a requesting entity;
send an allocation request message to a chassis that includes the chassis resource, the allocation request message requesting allocation of the chassis resource;
receive an allocation response from the chassis, the allocation response indicating the allocation of at least the requested chassis resource; and
present the allocation response at the requesting computer system.

37. A computer program product for use in a chassis that includes one or more network diagnostic modules and that is network connectable to a requesting computer system, the computer program product for implementing a method for managing the resources of the chassis, the computer program product comprising one or more computer-readable media having stored thereon computer-executable instructions that, when executed by a processor, cause the requesting computer system to perform the following:
receive an allocation request message from the requesting computer system, the allocation request message requesting allocation of a chassis resource;
determine if the requested chassis resource is currently being utilized;
refer to allocation rules to determine if the requested chassis resource can be allocated to satisfy the resource allocation request;
allocate one or more chassis resources according to the allocation rules; and
return an allocation response to the requesting computer system, the allocation response indicating the allocation of at least the requested resource.
